(19) United States
(12) Patent Application Publication
(10) Pub. No.: US 2002/0128935 A1
(43) Pub. Date: Sep. 12, 2002

(54) Many-to-many mediated commercial electronic publishing

(75) Inventors: Lockey White, Portland, OR (US); Geoffrey Hutchinson, Beverly Hills, CA (US); Dagan Short, Portland, OR (US)

Correspondence Address: KLARQUIST SPARKMAN, LLP, 121 SW SALMON STREET, SUITE 1600, PORTLAND, OR, 97204, US

(73) Assignee: Smart Mediary Systems, LLC

(21) Appl. No.: 10/095,994

(22) Filed: Mar. 11, 2002

Related U.S. Application Data
(60) Provisional application No. 60/275,196, filed on Mar. 12, 2001.

(51) Int. Cl. G06F 17/60

(52) U.S. Cl. 705/27; 705/51

(57) ABSTRACT

The invention introduces many-to-many mediated commercial electronic publishing, warehousing, marketing, and distribution of all types of digital content and electronic files. The system and method enables independent publishers to make available their authorial works to anyone with access to a machine capable of interpreting and displaying digital data, which includes an input means for the user to communicate with the system. The system further provides for instantaneous delivery of the purchased works. The system allows for independent authors to upload digital documents (and/or any other binary image) to a searchable database, define the terms of sale and descriptive information, protect document end-use with digital rights management, and retain all intellectual property rights and control at all times. The system also offers both publishers and purchasers the ability to conduct business without the need for individual human contact or disclosure of purchaser or seller contact information.

This application claims the benefit of U.S Provisional Application No. 60/275,196 filed Mar. 12, 2001.

### TECHNICAL FIELD

The invention relates to many-to-many mediated commerce in intellectual work product and information content. Furthermore, the invention allows real-time delivery of digitized copies of the product in trade.

### BACKGROUND AND SUMMARY

The current state of online publishing and electronic commerce systems is the one-to-many business model that presumes a business selling proprietary information to a consumer. The supplier bears the burden of producing or procuring all of the works of authorship and information content. Typically an online information content provider, such as a Web site, or television broadcast channel will produce or aggregate resource materials from a limited number of sources, for example in-house authorial talent or large supply houses. As a result, the sum of information is limited in breadth of field and depth of coverage.

Another inherent limitation of the one-to-many model is that independent individual authors have no way of offering their products to the market. The centralized content providers only purchase what they do not produce, and when outside purchases are made they are drawn from a limited pool of affiliated authors. The number of people who can make their intellectual work products' availability known to the market is limited. Independent authors wishing to offer their works for sale must pursue reception by a publishing organization. This method inevitably consumes both monetary and time resources.

Of the online intellectual work-product trading systems that do exist, none gives the user the ability to conduct the entire transaction in real-time. Typically, information consumers must register for memberships, subscribe to periodic publications, or join online listservs and mailing lists, which offer little-to-no interactivity or user choice. This method of trading in intellectual work product ignores the advantage of trading in purely informational products, that is the possibility of storing the product in digital form and making entire libraries uploaded from diverse individual content producers available to users for real-time searching and immediate real-time delivery at purchase.

Examples of the prior art in online publishing systems that do not allow for peer-to-peer publishing, digital product storage and maintenance, or real time access are U.S. Pat. No. 5,794,207 (a method for effectuating bilateral buyer-driven commerce), and U.S. Pat. No. 5,710,887 (a system for facilitating commercial transactions between a plurality of customers and at least one supplier over a computer driven network).

The illustrated embodiment provides advantages over existing technologies in several ways. It decentralizes content production thus avoiding the inefficiencies that result from proprietary content production and procurement. The illustrated embodiment creates an environment in which independent authors may funnel work product into the market without incurring the full costs of advertisement and transaction processing.

The illustrated embodiment allows independent authors to publish their work product in a way that did not exist before. Authors need not negotiate with publishing companies or spend time and effort trying to get their product noticed. The illustrated embodiment allows authors to benefit from the unifying nature of an Internet trading floor. The effort and resources required to generate public awareness of the system are spread among all who use it, and the market place is available to anyone with a computer terminal or similar interface capable of displaying information and communicating user input.

One embodiment relieves independent authors of the need to make public their own personal contact information, if they so desire. Authors need not release their contact information such as phone numbers or email addresses, thus avoiding providing an opportunity for marketers to obtain verified points of entry for unsolicited advertisement. To authors who do not want to disclose personal contact information, such an embodiment can be used as an intermediary. In such an embodiment, authors have marketing exposure, and the ability to communicate their professional background information if they so choose, without attendant disclosure of personal contact information. Similarly, buyers or users may also maintain anonymity.

It is a further object of the illustrated embodiment to enable online publishing companies to avoid incurring the liabilities associated with selling proprietary intellectual work product. In other selling models, where a content provider buys and then resells work product, the content provider assumes liability as to the quality of that work product. In the illustrated embodiment, ownership of the work product, and the associated liability, remains with the original authors.

The illustrated embodiment facilitates real-time accessibility to authorial works without the need for membership approvals, or subscriptions to periodic publications or any other intermediate arrangements that force content consumers to suffer delays in obtaining specific informational content (though memberships may be added later).

The described embodiment provides a method for many-to-many mediated trading in intellectual work product. In such an embodiment, computer software and hardware, and a communications network, and a system of associated databases that contain libraries of professional work product kept in digital form are used to mediate the transactions between users and authors. Patrons of such a system and methods will be able to both securely offer their work product to others, and to purchase work product of others.

The described embodiment comprises a method of obtaining intellectual work product from a disparate group of unassociated sellers and storing that product in a database system, organizing and sorting the documents, and related descriptive data (such as author, author's professional information, author's sale terms), verifying the integrity of the documents (e.g., against viruses), running user defined queries against the product database, making available to prospective purchasers certain portions of the descriptive product information, accepting the electronic payment from buyers or users, managing payment delivery to the seller or author, controlling end-use of the document with digital rights management, and delivering the product data to the buyer or user.

In the described embodiment, sellers (authors) are offered an easy method of submitting work product to the system via an Internet World Wide Web interface and are presented with a format in which to describe their work product making the communication of their product's value to prospective buyers or users more reliable. Authors or sellers have complete control over how their product's descriptive information is presented to the purchaser. Authors or sellers need not spend time dealing with prospective buyers, rather the system handles all queries from buyers looking for products and the system communicates to buyers the product description and sales terms. Sellers are also relieved of the need to process payments from buyers. A seller uploads a document, and the illustrated embodiment performs the rest of the functions necessary to conduct a sale, yet the seller maintains ownership and control of the document, and can edit or delete the document(s) and descriptive information at anytime. The illustrated embodiment handles all credit card payment processing and accounting for documents posted on the system. Document sellers have point and click access to an automated document sales reporting system that tabulates all credits due to the seller. Sellers need only post the document once, and the system handles all other tasks associated with “advertising” the product, negotiating the sale, settling the transaction, controlling end-use through digital rights management, and delivering the product to the buyer or user.

In one embodiment, the system instantaneously credits a seller's account with the proceeds of all sales as soon as they are made. In another embodiment, payments are mailed to sellers periodically.

Using the illustrated embodiment, buyers or users are given an easy-to-use interface for searching and reviewing work product information through a World Wide Web. In the illustrated embodiment, buyers search for work product information with Boolean or Natural Language search commands. The illustrated embodiment, allows users to run search queries from any computer terminal against a centralized structured query language relational database management system. Search results are presented allowing buyers to review the work product of disparate and unaffiliated producers from within a familiar interface, removing the need to learn a new method of categorization and description for each producer's work.

An alternative embodiment includes a means of facilitating communication between information consumers allowing the exchange of opinions concerning particular works available on the system. Such a feature would create an ideal marketplace in which consumers may educate themselves about the quality of a particular product without having to rely only on the assertions of the work's author or agent.

The illustrated embodiment allows buyers to pay with credit cards, however in another embodiment, payment is made via electronic funds transfer, debit cards, and digital cash, among others. The illustrated embodiment, gives the buyer the advantage of obtaining the product immediately through electronic document delivery.

Additional features and advantages will be made apparent from the following detailed description of the illustrated embodiment, which proceeds with reference to the accompanying drawings.

### BRIEF DESCRIPTION OF THE DRAWINGS

FIG. 1 provides an illustrated embodiment of a many to many mediated electronic publishing system.

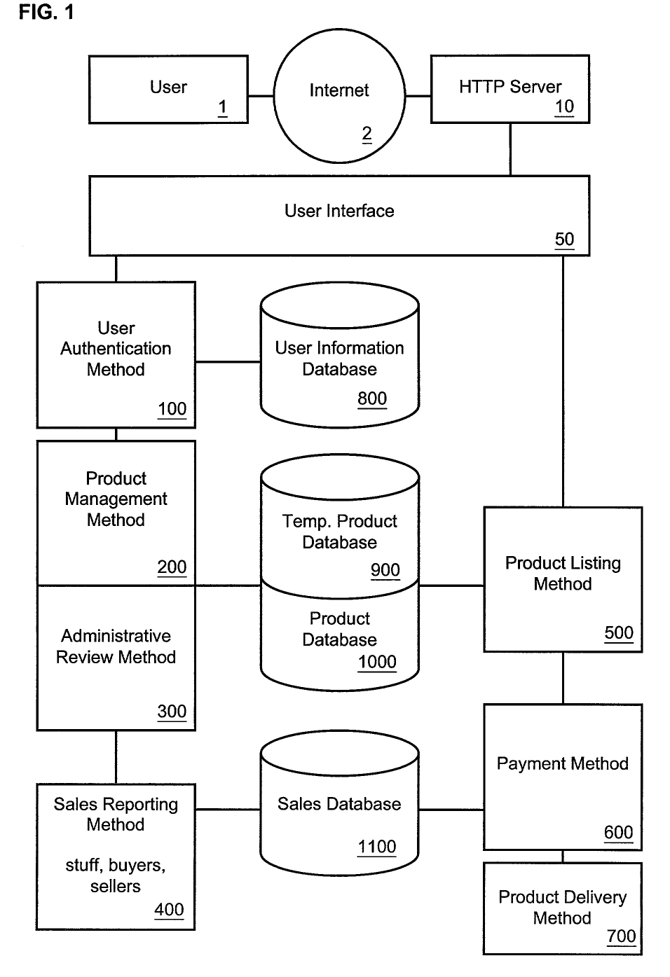

FIG. 2 is a flowchart showing a User Authentication Method performed in the system of FIG. 1.

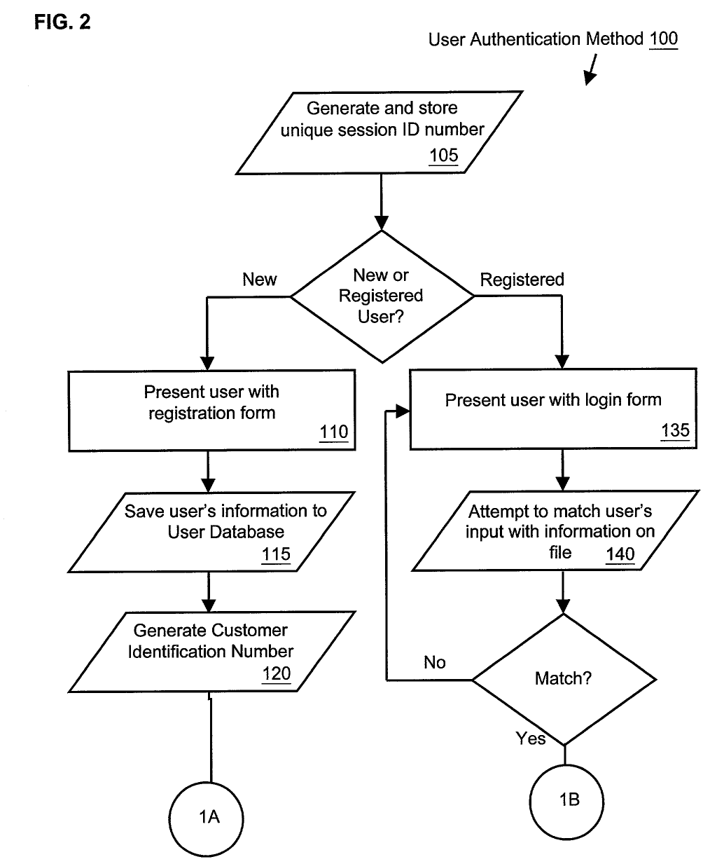

FIG. 3 is a continuation of the flowchart from FIG. 2.

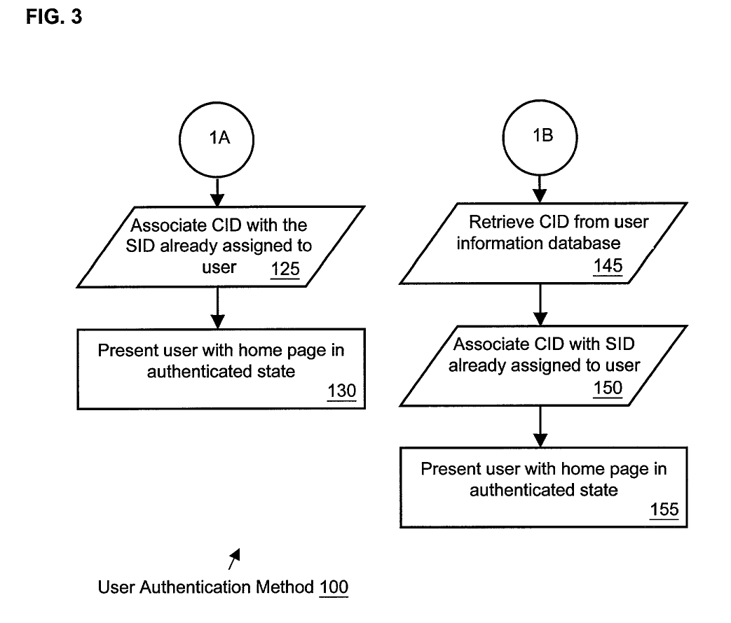

FIG. 4 is a flowchart showing a Product Management Method performed in the system of FIG. 1.

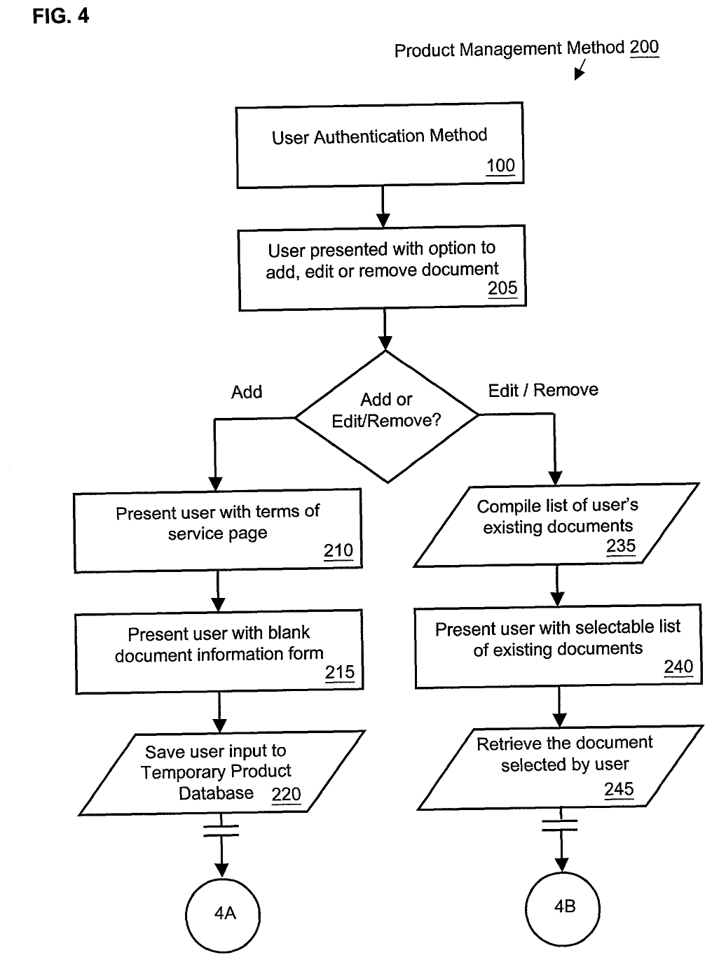

FIG. 5 is a continuation of the flowchart from FIG. 4.

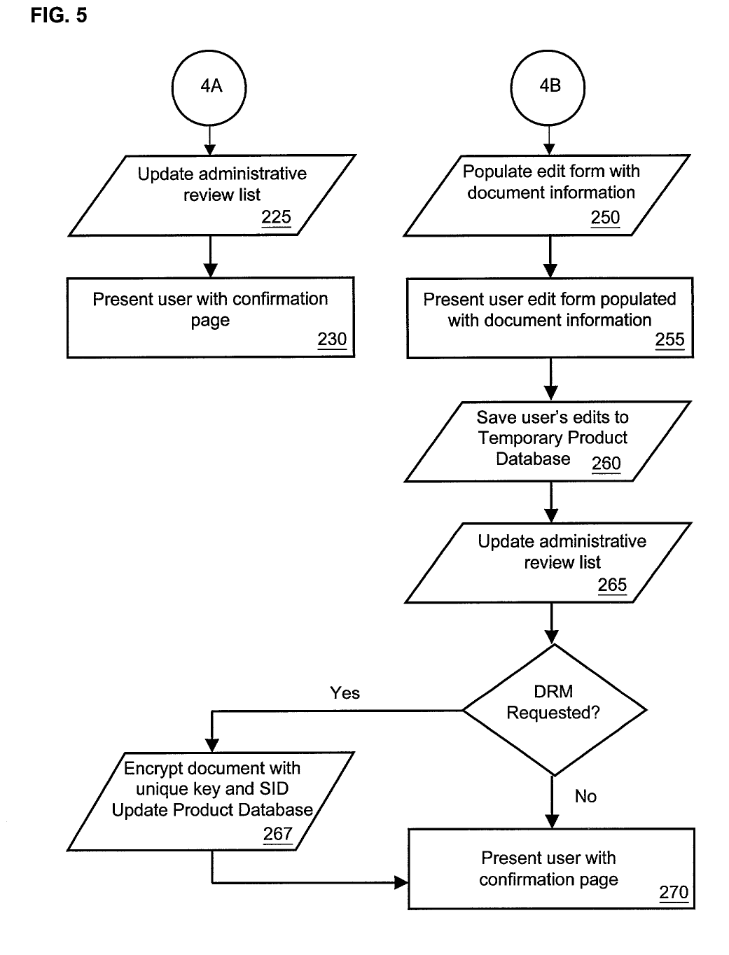

FIG. 6 is a flowchart showing an Administrative Review Method performed in the system of FIG. 1.

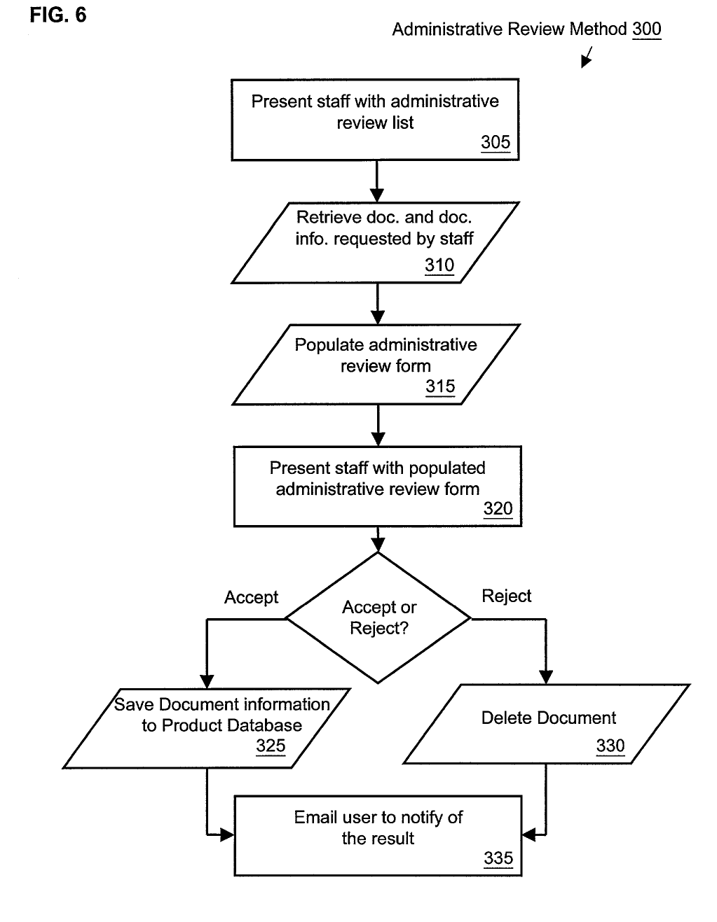

FIG. 7 is a flowchart showing a Sales Reporting Method performed in the system of FIG. 1.

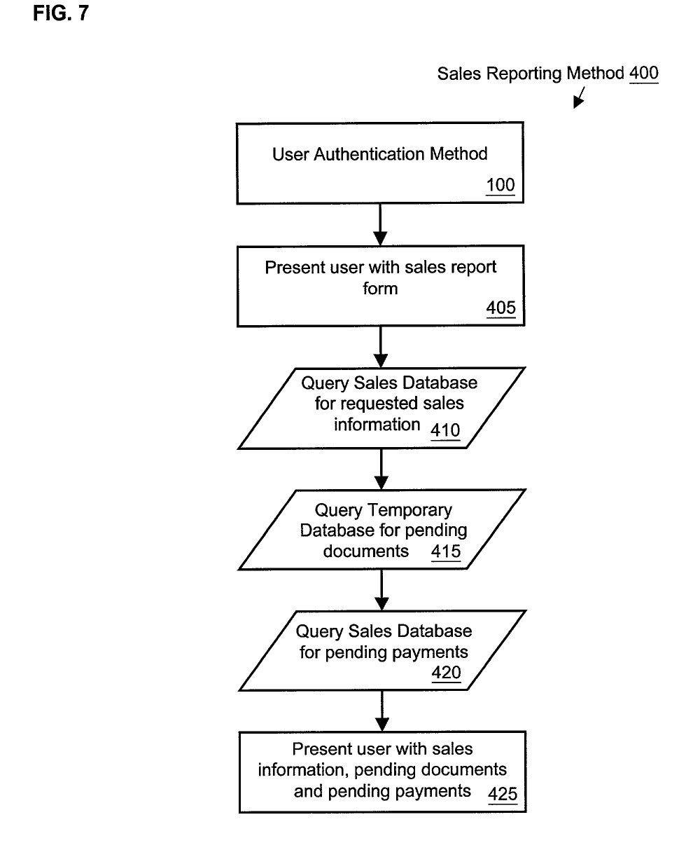

FIG. 8 is a flowchart showing a Product Listing Method performed in the system of FIG. 1.

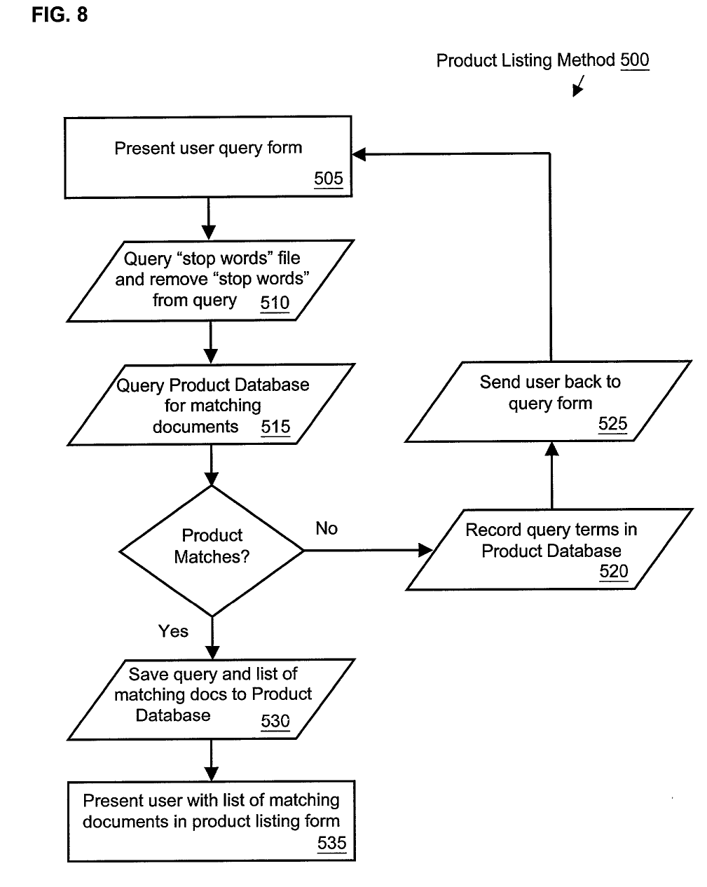

FIG. 9 is a flowchart showing a Payment Method performed in the system of FIG. 1.

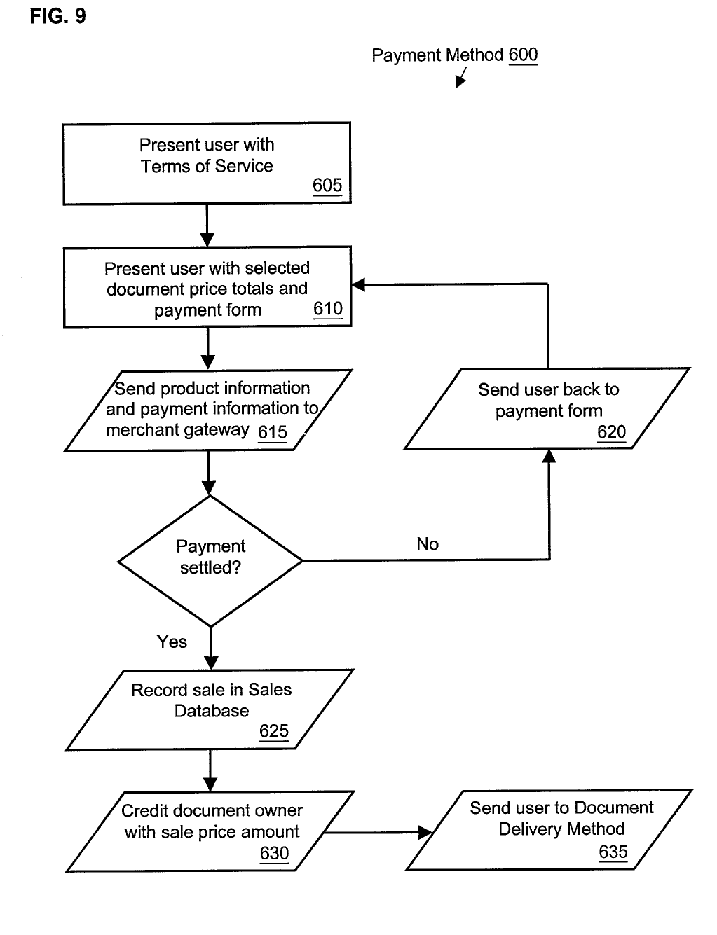

FIG. 10 is a flowchart showing a Delivery Method performed in the system of FIG. 1.

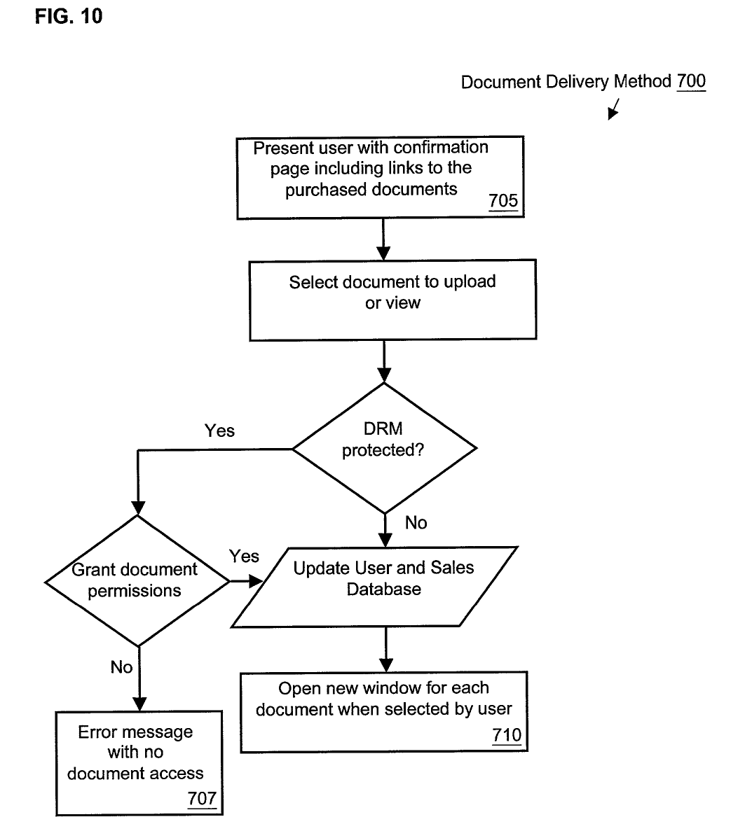

FIG. 11 is the New Account Registration Form as used in the User Authentication Method 100.

FIG. 12 is the Continuation of the New Account Registration Form as used in the User Authentication Method 100.

FIG. 13 is the Login Form as used in the User Authentication Method 100.

FIG. 14 is the Document Submission Form as used in the Product Management Method 200.

FIG. 15 is the Document Upload Form as used in the Product Management Method 200.

FIG. 16 is the Submission Form Confirmation Page as used in the Product Management Method 200.

FIG. 17 is the Document Inventory List as used in the Product Management Method 200.

FIG. 18 is the Document Edit Form as used in the Product Management Method 200.

FIG. 19 is the Document Edit Form Continued as used in the Product Management Method 200.

FIG. 20 is the List of New Document Submissions as used in the Administrative Review Method 300.

FIG. 21 is the Review New Document Submission Form as used in the Administrative Review Method 300.

FIG. 22 is the Review New Document Submission Form Continued as used in the Administrative Review Method 300.

FIG. 23 is the Document Sales Report as used in the Sales Reporting Method 400.

FIG. 24 is the Search Engine Form as used in the Product Listing Method 500.

FIG. 25 are the Search Results as used in the Product Listing Method 500.

FIG. 26 is the Shopping Cart Contents and Checkout Form as used in the Payment Method 600.

FIG. 27 is the Document Purchase Confirmation Page as used in the Product Delivery Method 700

### DETAILED DESCRIPTION OF THE INVENTION

A method and apparatus (online service) for information presentation and management in an online peer-to-peer commercial trading environment of intellectual work product are described. For the purposes of explanation, numerous specific details are set forth in order to provide a thorough understanding of the present embodiment. It will be apparent, however, to one skilled in the art that the present embodiment may be practiced without some of these specific details. The methods described in the present embodiment are designed to employ a client-server environment such as the World Wide Web. The user's browser allows the user to interpret communication from a server computer outfitted with the appropriate Web server software. The various software components that represent the methods of the current embodiment reside on this Web server and control the messages sent to and received from clients. The client-server model may be employed using the Internet, or private networks (intranets). Furthermore, the actual network architecture may be composed of wire line connections, wireless transmissions (i.e. cellular, radio, satellite), or any other means of transmitting information to an apparatus capable of interpreting and displaying it.

In another embodiment, authors or sellers of any form of binary image may upload such binary images and buyers search, purchase and take immediate delivery of such binary images. Those skilled in the arts would recognize that the illustrated embodiment facilitates trading any form of binary image including but not limited to documents, audio, video, images, executable images, and/or multi-media binary images. Binary images are well suited for this form of trading because networks in general facilitate the transfer of binary images (11100100011 . . . ). In this regard, the term “document” and “binary image” shall comprise all these forms of binary images.

In the present embodiment the following methods enable users to register with the system, post documents to the system for purchase by others, protect posted documents with digital rights management options, request sales reporting for posted documents, query the data sources for product listings, transact credit card payments, and obtain immediate electronic document delivery. The User Authentication Method 100 creates user accounts and identifies users with existing accounts by matching user input data stored in the User Information Database 800 to verify the identity of the user. The User Information Database 800 also contains information relating to any documents the user may have posted on the system and sales information relating to those documents. The Product Management Method 200 enables users (authors) to post (“upload”) digital documents to the system. An Administrative Review Method 300 is used to verify the integrity of the documents being uploaded (i.e., scanning for viruses, or inappropriate or non-informational documents). A Sales Reporting Method 400 connected to a Sales Database 1100 is employed by system users and internal staff to generate and view reports of document orders and sales.

To facilitate product sales, a Product Listing Method 500 with access to a Product Database 1000 is connected to a Payment Method 600 and Product Delivery Method 700 to allow buyers or users to find digital documents, transact a credit card payment for the document(s), grant user permissions if the document is protected by digital rights management, then immediately obtain (“download”) the newly purchased digital document(s). The Payment Method 600 is also used to update information in the Sales Database 1100 when sales are made.

For ease of explanation, the processes are described as if they are a single device. Many of the databases described are composed of multiple database tables containing related information, or a single database table composed of multiple fields. In alternative embodiments, each element may actually comprise multiple physical and/or logical devices connected in a distributed architecture, and the various functions performed may actually be distributed among multiple devices. In addition, the functions performed by the various services may be consolidated and/or distributed differently than as described. For example, the User Database and the Product Database may be distributed across separate server machines, or they may be combined in one database service on one server machine. In another embodiment, multiple servers and/or multiple databases are spread across the network. In an extension to such embodiments using multiple servers and/or multiple databases, the methods discussed herein are shared and/or partitioned amongst the servers and/or databases. In another embodiment, one database supports all such methods. In any case, the words storage, store, warehouse, or database shall comprise all such meanings.

User Authentication Method

A User Authentication Method is used to identify users (both authors and buyers) for purposes of allowing access to product management methods, to allow users (buyers) to access documents that they have purchased, and to properly credit users (authors) with sales of their posted documents. Using this description, any person skilled in the art will be able to determine how the various components work together. Any other third party software product capable of receiving user input and managing user information in a database could have been used.

As each new visitor calls pages from the system comprising the present embodiment, step 105 is performed wherein a unique session identification number (SID) is generated then stored in both the User Information Database 800 and on the user's computer in the form of a Cookie, if applicable. A Cookie is a small file deposited on the client system through an HTTP message to the user's browser. Cookies are retrievable by the server, again through an HTTP request, and are a method of identifying which browser (and by association, which user) is making requests to the server. The newly generated SID is used to track the activities of the user before the user's actual identity is known (i.e., before the user performs the registration or login method). In the present application, the SID is associated with any shopping basket the user or buyer may create by selecting documents from the Product Listing Method 500 described below. To initiate the present method the user may choose between accessing a form for registration or a form for logging in to an existing user account. If the user chooses to register for the first time the user is presented with the registration form at step 110. The registration form is delivered as a Web form, which contains input fields, associated with hidden variable names. The User Authentication Method uses the hidden variables to properly store the user input in the User Information Database 800 at step 115. After the information is successfully stored, the method involves generating a unique customer identification number (CID) at step 120. At step 125 the CID is stored in the User Information Database 800 in association with both the user's personal information and with a record of the SID deposited on the user's system at step 105. The user is now said to be in an authenticated state. At step 130 the user is presented with the home page in an authenticated state. The authenticated state is described further at step 155 below.

If the user initially chooses to log in to an existing account then the user is presented with the login form at step 135. The login form contains two fields, one for a user name and another for a password. At step 140 the method accepts the user's input from these two fields and attempts to match the two with a user account in the User Information Database 800. If no match is found, the user is presented again with the login form. If a match is found then step 145 is executed retrieving the user's CID from the User Database 800. At step 150 the user's CID is associated with the user's current SID. At step 155 the user is presented with the home page in an authenticated state.

After the user has registered, or logged in to the system the user enters an authenticated state. In the authenticated state, all pages served to the user's client system have embedded in each link within the page a CID indicator. Any calls to further methods from a user in an authenticated state will be made using URLs containing a positive CID indicator. For example, a call to the Product Listing Method 500 from a user in the authenticated state is made with a URL of the following format: /index.cgi?b=find&si=456786534&ac=3452. The CID indicator is found in the string of characters “ac=3452”. A CID indicator value of any number above zero (0) signals the next method that the user is authenticated. If the requested method is one in which a user's identity is required, then the SID is called from the user's Cookie file, if applicable, and cross referenced in the User Information Database 800 to find the user's CID. The reason a CID indicator is used, instead of embedding the user's actual CID directly in the URL is so that the CID may not be intercepted by a third party and used to interact with the system under false pretenses.

In another embodiment, a user connects to the system through a Virtual Private Network (VPN). A VPN is a method of connecting a client to a server over a private and secure network dedicated to a particular user or organization. The user authentication method in such an environment is made much simpler by the fact that only a designated user will be connected through the VPN channel. Thus, the server would know a user making requests from such a VPN and user authentication would be a simple matter of identifying the network address of the client computer.

Product Management

The Product Management Method 200 allows users or authors to post documents to the system. In general, authors are enabled to submit documents to the system using the User Authentication Method 100, a method for the creation of new product listings, and a method for editing or removing existing product listings.

At step 205 the author is presented with a Web page for choosing between uploading a new document to the system or editing a current document. Choosing to submit a new document takes the author to step 210. Choosing to edit, delete, or modify a document and its descriptive information takes the author to step 235.

At step 210 the author is presented with a page displaying the Terms of Service. To continue with the procedure for posting a document to the system, the author must indicate agreement with the Terms of Service. An affirmative response forwards the author to step 215. A negative response forwards the author to the home page, with an error message.

At step 215 the author is presented with a form allowing the author to enter information pertaining to the document to be submitted. The form also contains a field allowing the author to attach a document for uploading. Some of the information collected at this step includes author's description, summary of the document, the author's credentials, document title, digital rights management options (i.e., control viewing, printing, saving, and expiration date), price, library choice, type of document, and format. Further, the form may also contain a field allowing the author to indicate descriptive terms that should produce the document in a search. Once the form containing the author's input is submitted to the system, the present method performs step 220 by storing that information and the document itself to a Temporary Product Database 900 for later use by the Administrative Review method.

At step 225 the method will update a list of pending documents that need to be reviewed by administrative staff, through the Administrative Review Method 300, before being stored in the Product Database and made “live” on the system (i.e., searchable and purchasable by other system users).

At step 230 the author is presented with a confirmation page telling the author that the document was successfully added to the Temporary Product Database 900 with review pending.

At step 235 a list of all of a particular author's existing documents is compiled from the Product Database 1000 by matching and reporting all the documents in the database that are associated with the particular author. At step 240 the author is presented with a Web page containing the list of the author's existing documents. Each document title in the list is a link which, when selected, will initiate further steps of the present method to perform the desired actions on the selected document. Along with each document listing is also associated a link which enables the user to send a command to the system to delete the document from the Product Database 1000. If the author selects such a link, the selected document and its descriptive information is deleted from the system and the author is forwarded to step 270.

At step 245 the selected document and its related information are retrieved from the Product Database 1000 by the present method and presented to the author for editing. At step 250 the fields of a Web form are populated with the document information. At step 255 the Web form with the document information is presented to the author for making edits to the document. In the illustrated embodiment, the document seller or author is able to add, edit, or delete the document and its descriptive information at anytime using this method. At step 260, upon resubmission of the Web form by the author, the new document information and edits are stored to the Temporary Product Database 900. At step 265 the list of pending documents to be reviewed is updated signifying the need for administrative review. If digital rights management options have been selected, step 267 makes a copy of the original document for encryption and stores the original in a protected directory, while moving the encrypted document to the production platform, making it available for purchase. At the time of encryption, a unique key is generated for unencrypting the document. Information related to the document encryption, along with the global digital rights management options (i.e., allow viewing, printing, saving, and expiration date) are securely stored in the Product Database. The present embodiment uses FileOpen Systems WebPublisher2 (™) as the encryption mechanism for digital rights management protection. Documents may be individual or batch encrypted, before purchase or on the fly. One skilled in the art could use a wide variety of digital rights management software applications for this purpose. At step 270 the author is presented with a confirmation page relating that the method was successful. The document seller (author) remains in ownership and control of the document and its descriptive information, at all times in the illustrated embodiment.

In another embodiment, document description data could be obtained in a fully automated way by searching a document for keywords and categorizing a document based on the number of keywords counted in the document. In such an embodiment, the same document could be discovered later by buyers in many different searches based on the keywords contained in the document. Such an embodiment would limit an author's need to describe the document. In another embodiment, words in the document would be compared to a keywords database to determine with which groups of documents to associate a document. Another embodiment would not categorize documents at all but would simply allow full textual searches on the entire database content. Those skilled in the art would know or be able to access many other systems to automate document categorization and searching. In this regard, a search term, keyword search, or category search can all be called search terms.

In another embodiment, the invention is practiced without a method for allowing users to electronically transfer binary image files to the system for inclusion in the Product Database 1000. Instead, content providers wishing to include their works on the system may deliver a physical copy of a document, image or recording, to the site of the server. The work is then scanned or otherwise digitized, as appropriate, and input to the Product Database 1000 from the physical location of the server.

Administrative Review Method

An Administrative Review Method 300 is provided to allow staff to review and perform quality control on documents uploaded by users (authors) for inclusion in the Product Database 1000. When called, the Administrative Review Method gives the staff member a Web based interface that allows the staff member to review the documents and the related information residing in the Temporary Product Database 900.

At step 305 the staff member is presented with a list of all pending documents. The staff member may then choose a document to work with. The staff member may use the present method to review the document itself, as well as the descriptive information.

At step 310 the present method will retrieve the document and descriptive information from the Temporary Product Database 900. At step 315 editable fields on a Web page form are populated with the document descriptive data and the document itself. At step 320 the form is presented to the reviewing person (staff). Typically, a pending document review involves looking for clearly incomplete or damaged data, and possibly inappropriate information from an abuser of the system. When the review is complete the reviewer may choose to accept or reject the current document. If the document is accepted, step 325 is performed and the document and its descriptive information are stored in the Product Database 1000. If digital rights management options are requested, the original document is copied and moved to a holding area. The copied document is then encrypted with a unique key, and made available for purchase. Information related to the encryption of the document (i.e., document number, encryption key, and service number) and the rules set (i.e., whether viewing, printing, or saving is allowed) are also stored in the Product Database.

At step 335 an email is sent to the user (author) detailing the results of the administrative review method.

In another embodiment, there need be no administrative verification of document content, rather the buyer assumes all responsibility of loss. In a variation of such an embodiment, the system would offer a reporting system for buyers to post complaints about a document seller, and a way for the document seller to respond to such complaints; and a way for future other buyers and sellers to read such comments about the experiences that other buyers or sellers had with a given buyer or seller. In such an embodiment, sellers could also post comments about dealings with buyers. Sellers or buyers failing to deal honestly would face information policing allowing others to avoid future dealings with them. In a variation of such an embodiment, buyers and sellers are rated using a system with such factors as number of buys or sells, number of refunds, number of complaints, and etc.

In another embodiment, administrative verification is automated. For example, the document is spell-checked and grammar checked, actual keywords are checked against those stated by a seller, content can be measured in word count, documents with multiple repeat words are prohibited, and documents containing pornography or profanity are blocked. Those skilled in the arts would understand a multitude of ways to filter content and/or offer advanced information about content to a buyer. Another embodiment would simply allow a buyer full refund without question for a limited period. In such an embodiment, a buyer with a repeat refund track record could be prohibited from buying.

Sales Reporting Method

The Sales Reports Method 400 allows both users (authors and buyers) and staff to review the order and sales activity of documents in the system. First the User Authentication Method 100 is performed to determine which user seeks sales reports. If a staff member logs in using a staff login, then unlimited access to the sales reporting functions are given. If a system user logs in, the user will only have access to reporting information relating to the users own documents.

At step 405 the user (author) is presented with a Web form allowing the user to indicate what type of report the user wishes to see. The information reported by this method includes document titles, author, post dates, numbers of sales, and total revenues. The method can also present aggregated statistics including sales records for the entire system filtered by various criteria such as periods of time, or document owner. Furthermore, the method will report to a given user whether any outstanding payments are due to the user.

At step 410 the Sales Database 1100 is queried for the information requested by the user (author). At step 415 the Temporary Product Database 900 is queried for any pending documents belonging to the current user. At 420 the Sales Database is queried for sales records of the user's documents. The sum of all proceeds gained by sales of the user's document(s) is calculated. Any payments already made to the user for the sales of posted documents is subtracted, and result is the money owed to the user at the time of the user's request for an accounting.

At step 425 the user (author) is presented with a Web page containing the information requested, which may include, according to the user's request, sales revenues for a particular document, sales revenues for all of a given users' documents, payments made to the user for those sales, and payment due to the user from those sales.

In another embodiment, authors gain proceeds from the sales of posted documents through an aggregated membership model. In such an embodiment, information consumers pay a monthly or annual membership fee. In turn, sellers receive a percentage of all revenues generated from purchaser memberships according to the frequency with which the documents the author has posted are retrieved.

In an alternative embodiment, no electronic sales reporting method is used. Instead, all accounting for sales, and proceeds due to the selling authors is calculated manually, and accounting reports are distributed in physical form (i.e., account summaries mailed periodically).

Product Listing Method

The Product Listing Method 500 presents users with a Web page including a form that accepts a search query from the user (buyer) to be run against the Product Database 1000.

At step 505 the present method displays to the user (buyer) a Web page containing a form accepting a search query in a Boolean or Natural Language search format. The user (buyer) may input a search query, and upon resubmission of the form, at step 510 the present method uses a full-text search engine to scan the entire text of each document. All “stop words” (e.g., that, then, to, it, be, etc.) are ignored in the search query.

If a match is found the user (buyer) is advanced to step 530, where the search results are presented in a ranked descending order based on statistical relevancy. If no match is found, step 520 is performed, storing the query in a query record table in the Product Database 1000, and at step 525 the user (buyer) is sent back to the query form at step 505.

At step 530 the query along with the list of matching documents is stored in a query record table in the Product Database 1000. At step 535 the offer price of the documents matching the user's query are adjusted to include a transaction fee and the user is presented with the list of matching documents in a Web form capable of accepting a user's indication of which documents, if any, to add to a list of documents to be purchased.

Matching records are sorted according to a ranking algorithm. Documents containing the highest frequency of matches to the user's query are presented first, and those with the query terms occurring less frequently are presented in descending order. The search component also performs root expansion. Root expansion is a method of widening the scope of a search to include words that have a common root within a query term.

In another embodiment, the user (buyer) may elect to refine a previously executed query by running a second query against the search results from the first.

In another embodiment, documents are indexed and searchable based on keywords, authorship, title, editor, state, genre, area of interest, and/or any combinations of the above. Topical indexes are then presented to the user for drill down directory style navigation. One skilled in the arts would recognize a number of ways to search and index documents.

In another embodiment, prior purchasers of a document are sent an email or other communication whenever the purchased document is edited by the document owner, or whenever a document owner indicates a portion of the document has become obsolete.

The current embodiment employs custom developed software to perform the tasks of tracking which documents the user (buyer) wishes to purchase (shopping basket functionality). The payment gateway is provided by LinkPoint International for credit card payments. The Web page form generated and presented to the user in step 535 has for each document listed a product code embedded in the link associated with it. Also embedded in each link is the unique session identification number of the particular user (buyer). The user may click on the link associated with a particular document to have the system send a message, via HTTP protocol indicating that the user with the session identification number embedded in the URL wishes to purchase the document associated with the product code embedded in the link.

One skilled in the art of Web programming will know that many third party shopping cart software programs are available, and indeed, that one may be developed using any number of programming languages capable of interacting with a Web server via CGI (the Common Gateway Interface). In fact, an entire software program could be developed using any number of programming languages to perform all the methods necessary to serve Web pages and handle the shopping cart functions needed to effect payment transactions over the Internet. As stated earlier, such software could be designed to work over television broadcasts, wireline telephone circuits, cable, wireless, and any other means capable of passing communications between a client and a server system.

Payment Method

The Payment Method 600 performs all payment transactions. In this embodiment, custom developed software is used to fulfill this method. Any number of similar products available from companies such as WebCart (™), WebOrder (™). FreeMerchant (™), and others could have been used.

In order to enable the payment software to perform its function, certain information must be passed to it from the system. The document product code, and the session identification number (SID) of the current user must be passed to the payment software. The rest of the information necessary to conduct the transaction, including the adjusted document price, the document title, and applicable sales tax are stored in the Product Database.

In order to initiate this process, the present method responds once the user clicks a link provided at step 535 during execution of the Product Listing Method 500. As stated, each document listed for the user at that step has associated with it a hyper-text link. Each link contains the information necessary to inform the payment software of which user is requesting the payment method (the session identification number), the particular document the user wishes to purchase (i.e. the product code), and an indication that the particular document should be reserved for purchase by the user (a specification of which action the user's wishes the Payment Method 600 to perform). This information is passed to the payment software by way of the requesting URL. When this page is called, with the appropriate information embedded in the calling URL (i.e., the code of the product to be added and the session identification number of the current user), the specified function is performed. The product designated by the code in the URL is added to a shopping basket belonging to the user (buyer) associated with the session identification number in the URL. This method can be repeated to add more documents to the shopping basket of a particular user.

At step 605, the present method responds to a user's decision to begin the payment procedure by presenting the user with terms of service. The user must indicate agreement with the terms in order to proceed. If the user does not agree, the user or buyer is returned to the home page.

At step 610 the user is presented with a list of all the documents the user has chosen to purchase (i.e., those added to the current shopping basket), along with the total adjusted price for all the documents (i.e., to reflect a transaction fee imposed by the system), and a secure payment form which allows the user to input credit card payment information including credit card number, name as it appears on the credit card, and billing address.

Upon resubmission of the payment form, step 615 is executed by the payment software. The payment information is sent to a merchant gateway, in this case, the Linkpoint (™) gateway, which is a commercial service capable of communicating payment requests from the gateway to the purchaser's credit card underwriter. If the payment transaction is successful (i.e., the payment software receives a positive response from the Linkpoint (™) gateway) then the user (buyer) proceeds to step 625. A payment receipt is also sent to the user (buyer) in the form of an email. If the payment is not successful, then step 620 is performed sending the user back to the payment form at step 610.

At step 625 the successful sale is recorded in the Sales Database 1100. Information saved at this step includes the purchaser's identity (more specifically the user's CID), a list of the document(s) purchased, and corresponding prints (digital rights permissions), if applicable. At step 630 the document(s)' owner(s) are credited with the sales of their documents in a separate table within the Sales Database 1100.

At step 635 the user or buyer is forwarded to the Document Delivery method 700.

In another embodiment, no real-time payment processing is used. Instead, users pay a one-time fee for membership to the system. Thereafter, the user may retrieve any binary image data from the system during the time period of the membership.

In an alternative embodiment, users may pay a one-time fee for the equivalent number of credits with the system. The user may then retrieve binary image files without conducting a credit card payment, or other electronic debit involving a third party such as a bank. Instead, the users credit account is debited for each binary image file retrieved according to the price of the particular work retrieved.

Document Delivery Method

The Document Delivery Method 700 is initiated after a successful payment transaction.

At step 705 the user (buyer) is presented with a confirmation page indicating that the payment transaction was successful. On this page are links to each of the purchased documents (listed by product code and document title). Each of these links is associated with its respective document on the server. That is to say that the URL for each document link points to the copy of the document residing in the Product Database 1000.

If the document purchased is protected by digital rights management, a server request for granting access is made each time the document is opened. This request is generated by FileOpen Systems client-side plugin and contains the document product number and type of permissions asked for (i.e., viewing and quantity of prints). The rules set, or rights that govern the document are first accessed from the Product Database. The request is evaluated against the rules set to determine if it is permissible. If the request is possible then the Sales Database is accessed to determine if the user (buyer) has purchased access to the document. If the user was not found to have purchased the document, an error message is produced informing the user to purchase the document before viewing. If approval has been granted or there is no protection, a new browser window is opened for each document link the user (buyer) selects, at step 710. This is accomplished through the use of Javascript (™) commands residing in the HTML tags used to demarcate the links for each of the purchased documents.

In an alternative embodiment, access to any product databases is restricted based on a user's security clearance. In such an embodiment, access to a product database is allowed on a per user basis, and only users with the appropriate clearance are allowed to access documents specified according to the level of their clearance. An example would be allowing a user with a valid membership to access the entire database of binary images. Alternatively, each binary image could be keep secure (i.e., inaccessible to all by default), and only users with clearance gained from paying for a particular binary image could be identified to the database for clearance to access specified documents.

In another embodiment, delivery of the newly purchased binary images is effected through email to the user. In another embodiment, all of the newly purchased documents are combined into a batch file, or archive, and the single archive is then made available to the user (buyer) for download. In yet another embodiment, binary images are sent directly to the printer functionality on the client system.

Description of Screen Shots

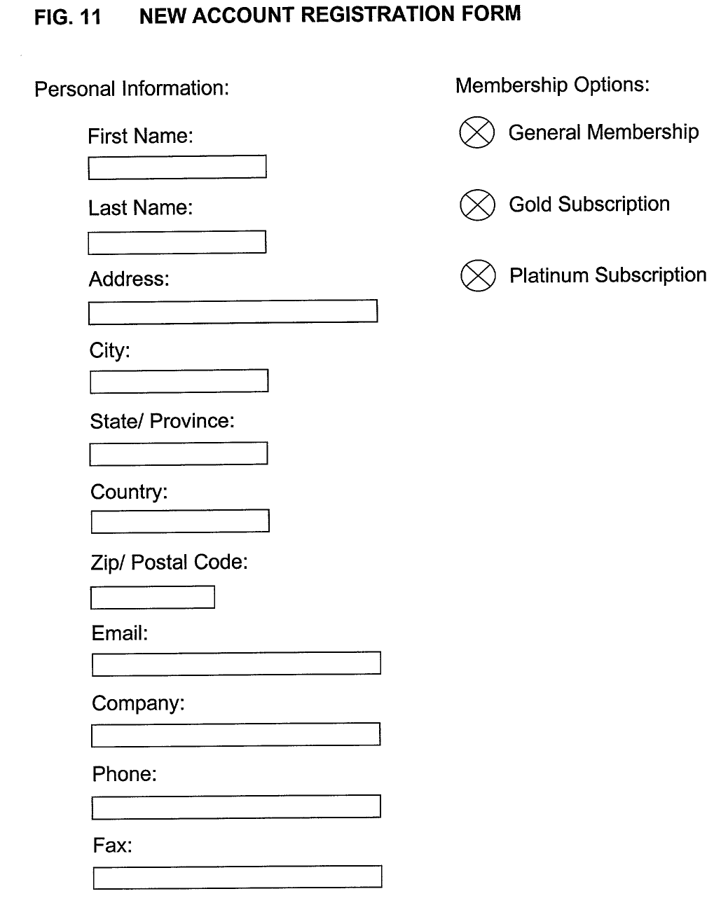

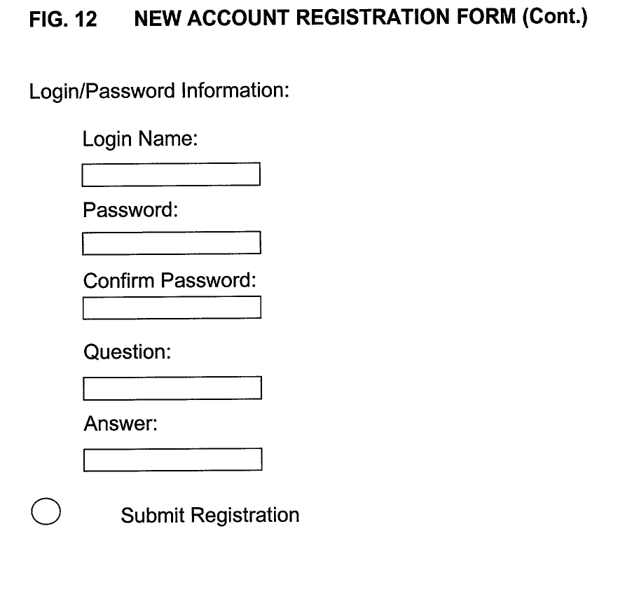

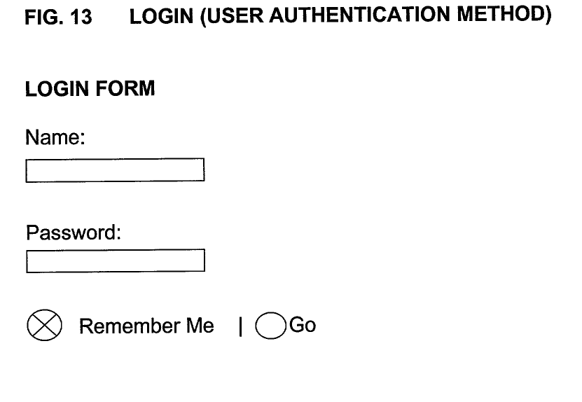

For the illustrated embodiment, the following screen shots could be used as a series of transactions. A new user (author or buyer) must sign up for an account before having access to membership account privileges. FIG. 11 and 12 shows the New Account Registration Form (User Authentication Method-Step 110) for new users. For users that have pre-registered, FIG. 13 (User Authentication Method-Step 135) shows the Login Form for obtaining an authenticated state.

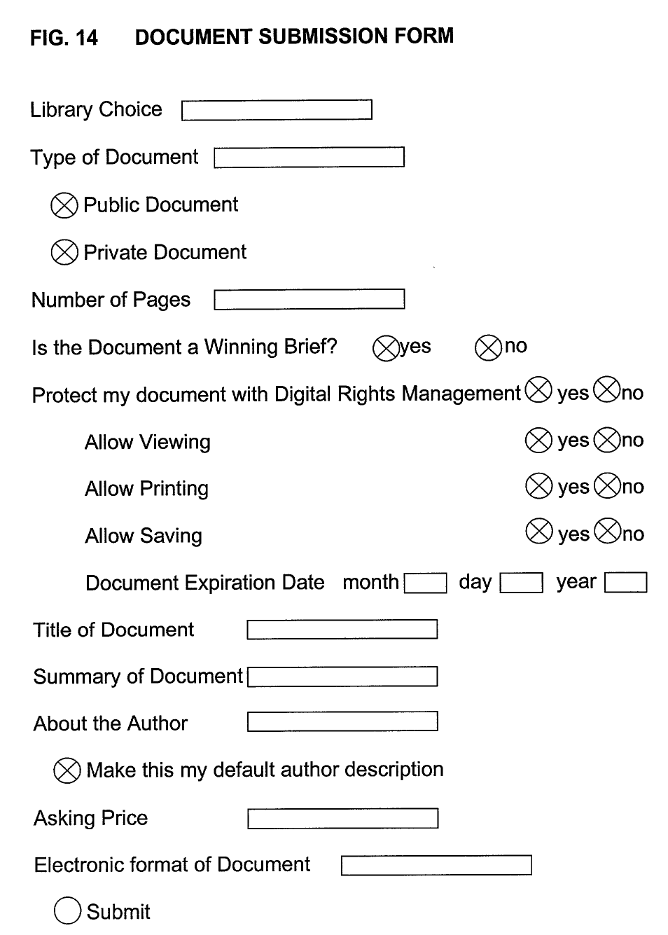

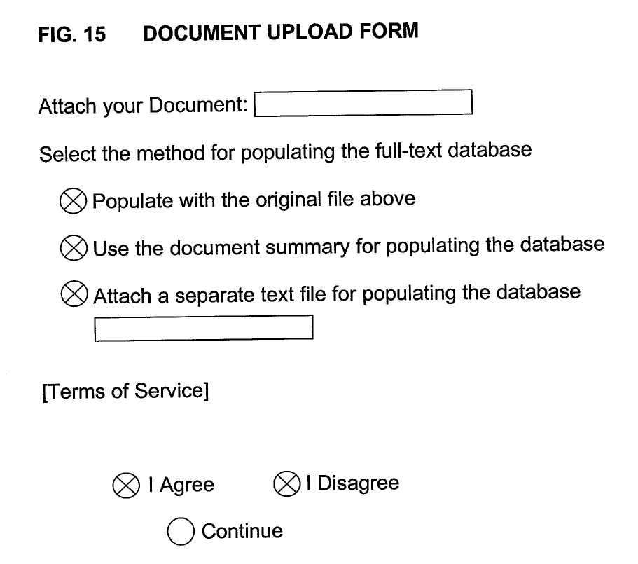

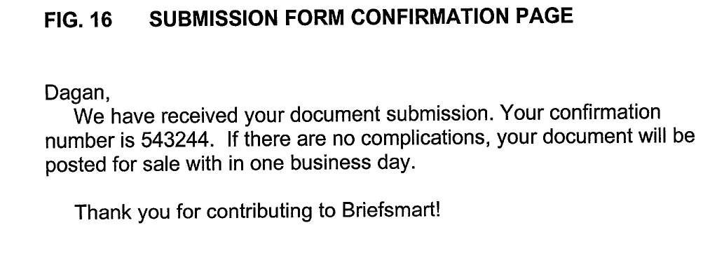

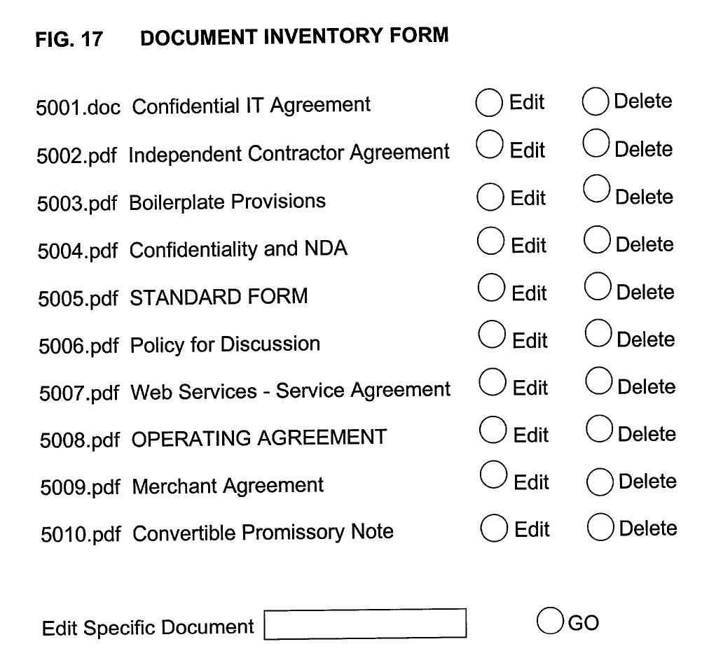

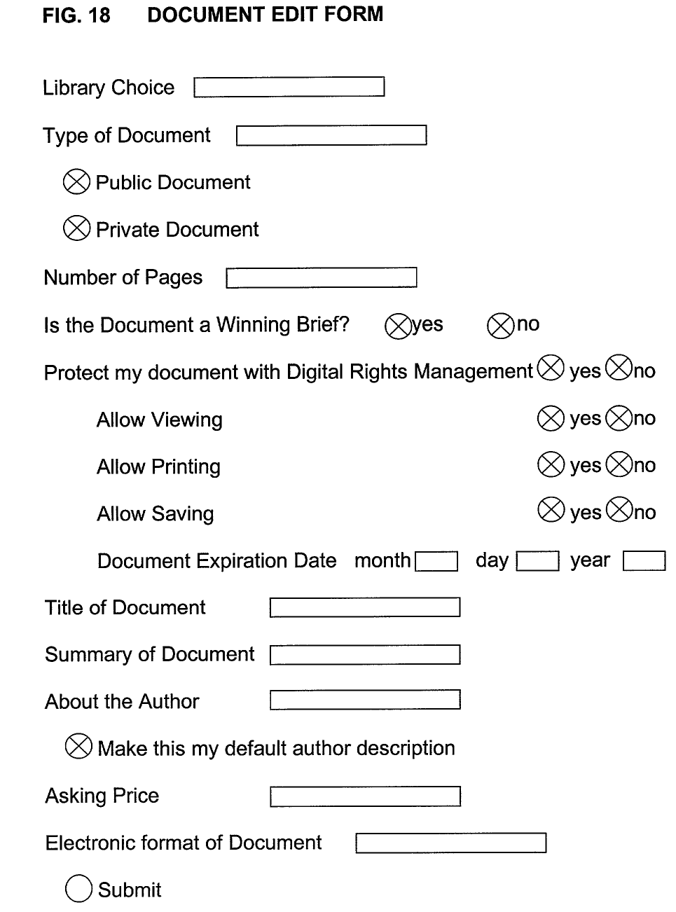

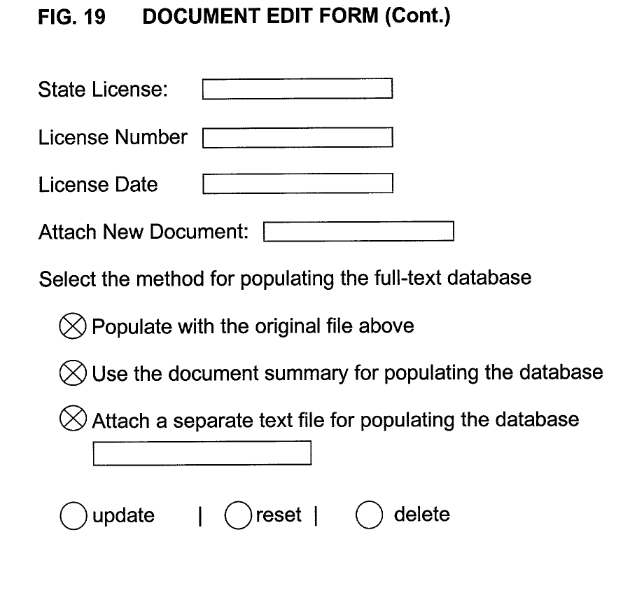

FIG. 14 shows the Document Submission Form used for submitting a documents descriptive information to the Temporary Product Database (Product Management Method-Step 215). After the documents descriptive information is uploaded and confirmed, the Document Upload Form (seen in FIG. 15) is presented to the user (author) for attaching the document and populating the text field of the database for full-text searching (Product Management Method-Step 215). FIG. 16 shows the confirmation page that the user (author) receives after posting their document (Product Management Method-Step 230). To review a complete list of documents that have already been posted to the system, FIG. 17 shows the Document Inventory Form, which allows users (authors) to review a list of documents for editing or deleting (Product Management Method-Step 235). If a user (author) chooses to edit an existing document, the Document Edit Form is used, as seen in FIGS. 18 and 19 (Product Management Method-Step 255).

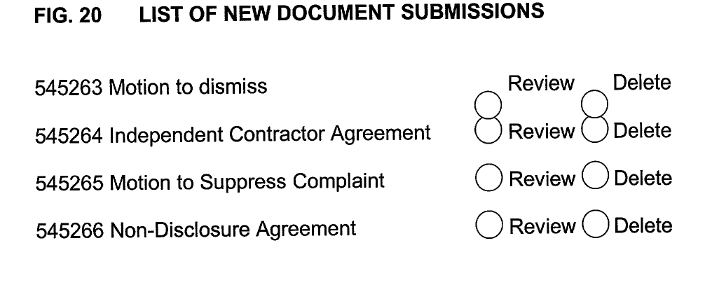

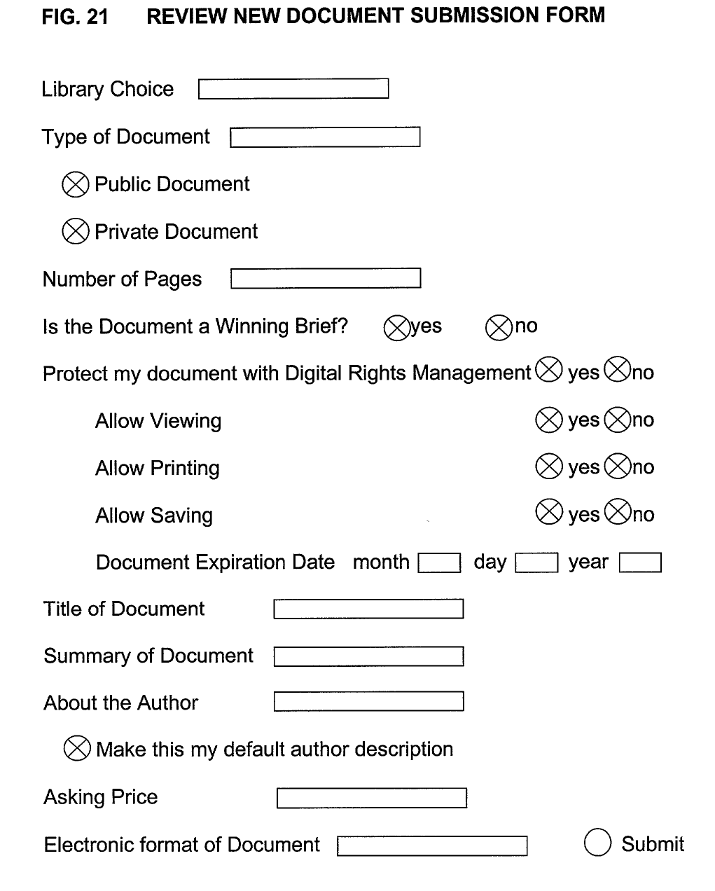

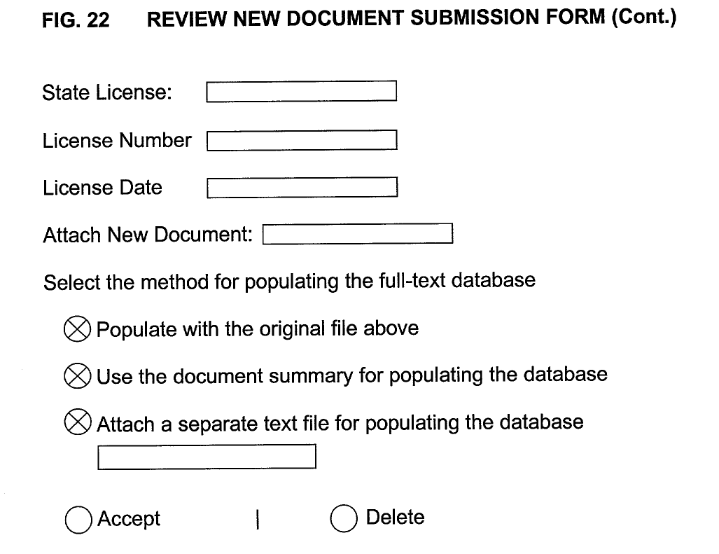

To review newly uploaded documents to the system from the Temporary Product Database, a List of New Document Submissions, as seen in FIG. 20, is reviewed by authorized staff (Administrative Review Method-Step 305). Each document submission is then selected and evaluated by staff for quality assurance and control by the Review New Document Submission Form, as seen in FIG. 21 and 22 (Administrative Review Method-Step 305).

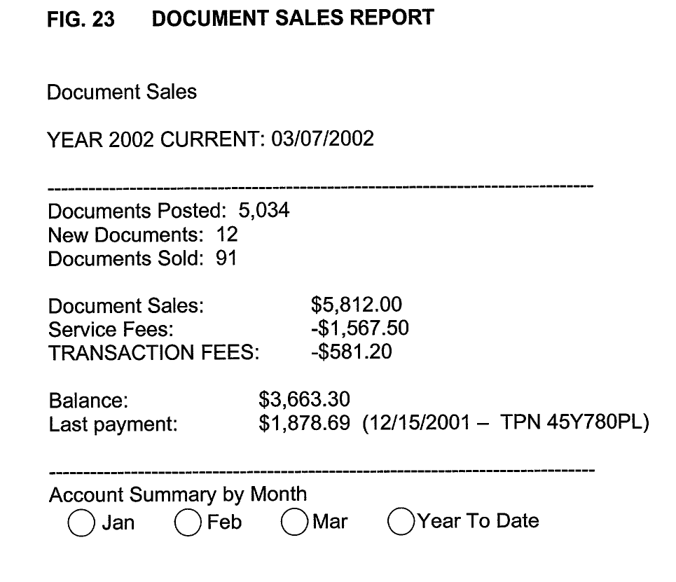

If the user (author) so chooses, a document Sales Report (FIG. 23) may be generated showing total documents posted, new document posts, total amount of documents sold, gross and net sales revenue, balance due, and last payment amount and date (Sales Reporting Method-Step 405 and 425).

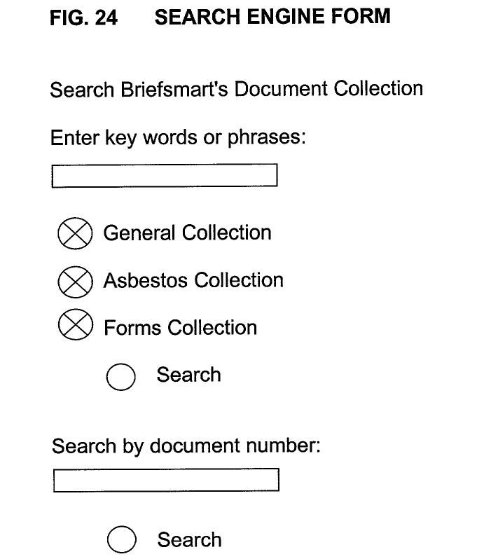

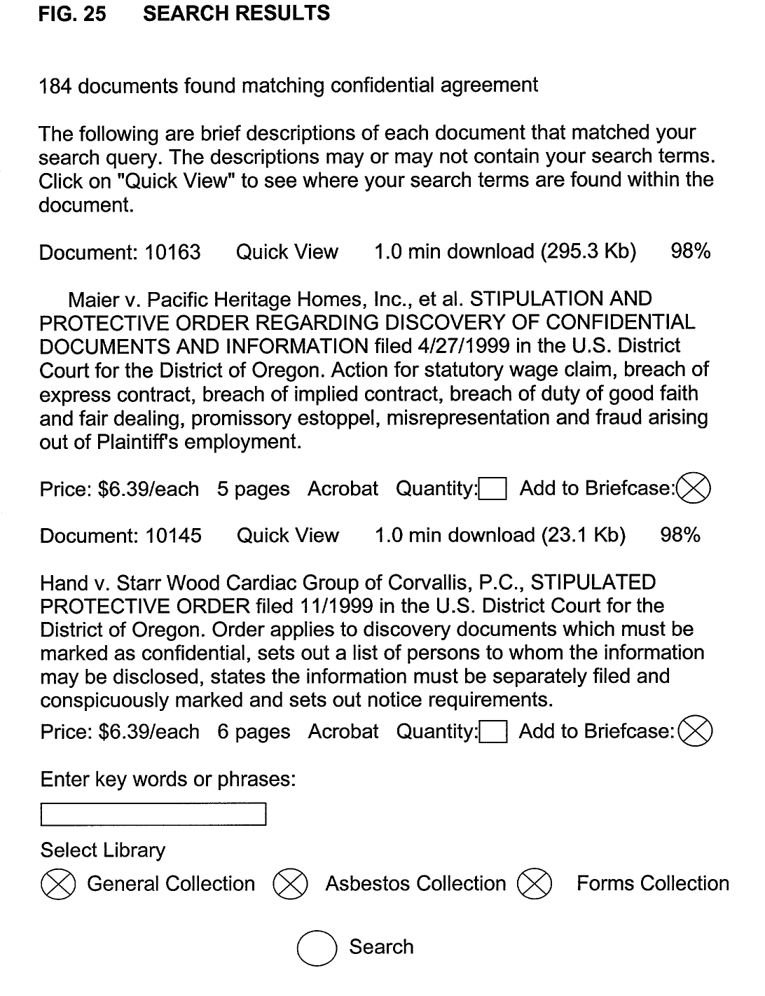

Documents are found via a full-text search engine as described in the Product Method 500. As seen in FIG. 24, a search query is made in the Search Engine Form for locating a document (Product Listing Method-Step 505). If a positive match is found for the search query, a listing of search results, as seen in FIG. 25, is presented to the user (buyer) in a ranked descending order based on statistical relevancy (Product Listing Method-Step 535).

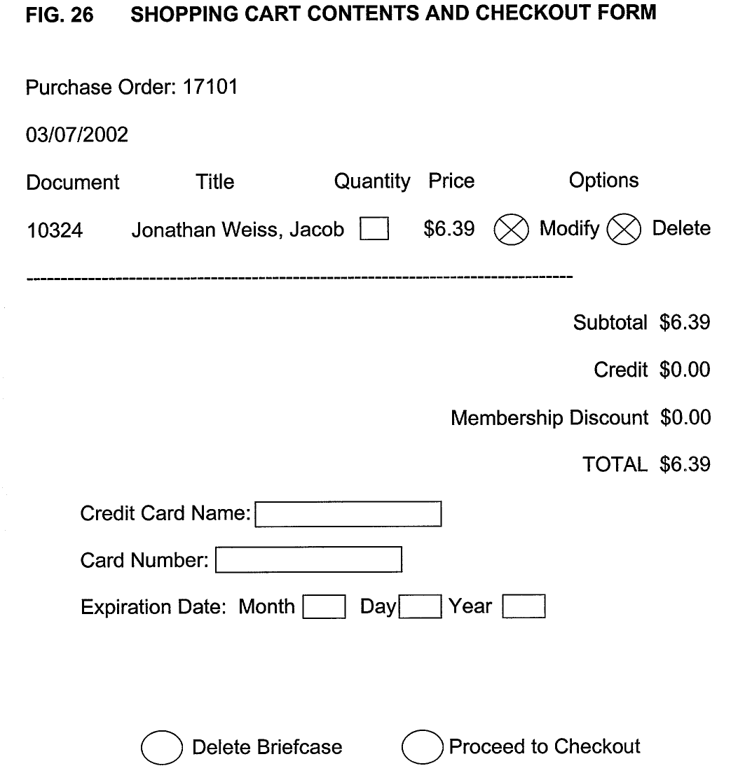

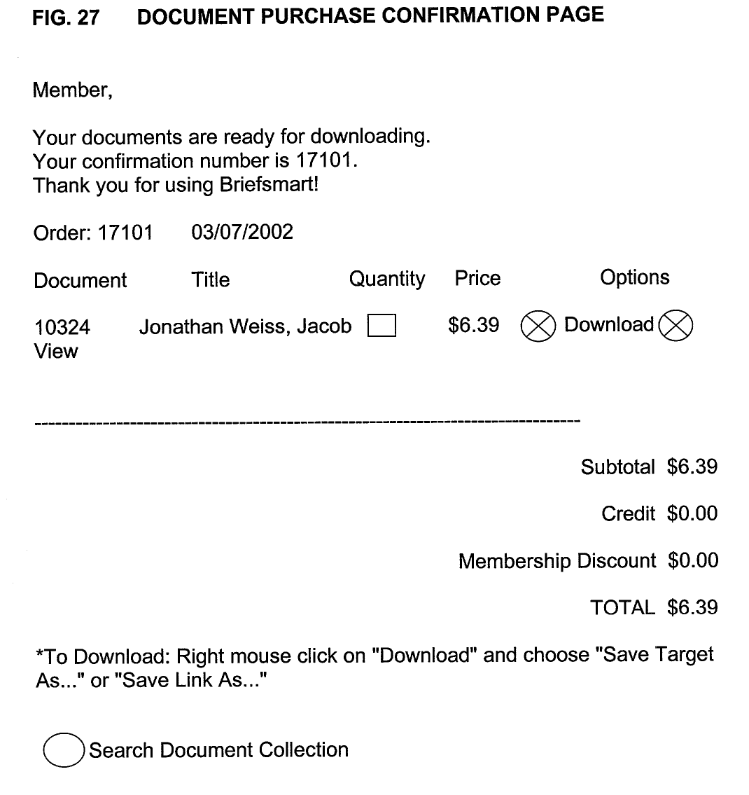

If a user (buyer) finds a document that they would like to purchase they may add it to a customized shopping cart. When the user (buyer) is done “shopping”, they may proceed to a Shopping Cart Contents and Checkout Form, as seen in FIG. 26 (Payment Method-Step 610). All documents selected for purchase are referenced with a total purchase price. Credit card name, number, and expiration date are collected for processing through the payment gateway. If the Merchant Account authorizes the payment, the documents are then delivered to the user (buyer) by the Document Purchase Confirmation Page, as seen in FIG. 27 (Product Delivery Method-Step 705). A link referenced to the document located on the server is given along with a document number, purchase amount, unique confirmation number and order number.

While the foregoing discussion has detailed a complete system, it employs many inventive concepts—each of which is believed patentable apart from the system as a whole. Furthermore, the use of sequential numbering to distinguish the methods employed is used for descriptive purposes only, and is not meant to imply that a user must proceed from one method to another in a serial or linear manner.

In view of the many different embodiments to which the above-described inventive concepts may be applied, it should be recognized that the detailed embodiments are illustrative only and should not be taken as limiting the scope of our invention. Rather, we claim as our invention all such modifications as come within the scope and spirit of the following claims, and equivalents thereto.

We claim:

1. In a network computing environment a method for facilitating the sale of binary images, a plurality of clients, a server, a searchable binary image storage comprising plural binary images, allowing clients through the server to offer binary images and to purchase binary images, each binary image removable from the searchable binary image storage by the server, each binary image removable from the searchable binary image storage by the client offering the binary image, allowing clients to request a search of the searchable binary image storage based on a search term, and allowing a client to purchase, pay for and take immediate network delivery of any binary image identified using the search term, the method comprising:
receiving a request from a first client to submit a first binary image;
sending the first client a binary image submission form(s);
receiving the binary image submission form(s) and the first binary image;
determining from the binary image submission form(s) a first binary image offering price;
storing the first binary image in the searchable binary image storage;
receiving a request from a second client to search for binary images, the request comprising a search term;
identifying the first binary image based on the search term;
sending a form(s) to the second client that the first binary image is available for purchase at the first binary image offering price and a proposed method for payment;
receiving a form(s) from the second client, the form(s) requesting to purchase the first binary image and authorizing payment for the first binary image offering price using the proposed method for payment;
sending a copy of the binary image to the second client; and
indicating the purchase in an account of the first client.

2. The method of claim 1, further comprising:
receiving a request from the first client to remove the first binary image from the searchable binary image storage;
removing the binary image of the first binary image from the searchable binary image storage;
sending an indication to the first client that the first binary image has been removed from the searchable binary image storage.

3. The method of claim 1, further comprising:
after receiving the first binary image from the first client, determining whether to place the first binary image in the searchable binary image storage;
protecting the first binary image with digital rights management; and
sending an indication to the first client that the first binary image has been placed in the searchable binary image storage.

4. The method of claim 1, further comprising:
after storing the first binary image in the searchable binary image storage, receiving a request from the first client to edit the first binary image;
sending the first client a copy of the first binary image;
receiving from the first client an edited version of the first binary image; and
in the searchable binary image storage, replacing the first binary image with the edited version of the first binary image.

5. The method of claim 1, further comprising:
receiving a request from the first client about the account of the first client; and
sending a report to the first client indicating the sales of the first binary image.

6. The method of claim 1, wherein the binary image submission form(s) contain input fields for the first client to insert descriptive search terms thereby allowing the first client to direct for a given search term, whether the first binary image is identified during a search.

7. The method of claim 1, wherein the binary submission form(s) contain input fields for the first client to indicate a professional qualification for an author(s) of the binary image.

8. The method of claim 1, wherein the binary submission form(s) require a representation that an author(s) of the binary image is an individual qualified by a qualifying organization.

9. The method of claim 1, further comprising:
receiving a request from the second client to submit an evaluation of the quality of the binary image;
sending the first client a binary image evaluation form;
receiving the binary image evaluation form;
associating data received in the binary image evaluation form with the binary image; and
presenting the data to a next client considering purchasing the binary image.

10. The method of claim 1, further comprising:
receiving a request from the second client to access the binary image;
determining whether the request to access the binary image is an access type permitted by an indication contained in the binary submission form(s) received from the first client; and
sending the first client an access authorization code if the access type is permitted.

11. The method of claim 4, further comprising:
sending a message to the second client indicating that the first binary image was replaced with the edited version of the first binary image.

12. The method of claim 4, further comprising:
sending the edited version of the first binary image to the second client.

13. A binary image obtained by a client using the method of claim 1.

14. In a network computing environment, a system for assembling binary images from plural clients and distributing binary images to plural clients, the system comprising:
a means for storing binary images in a warehouse;
a means for a client to upload a binary image into the warehouse;
a means for protecting documents with digital rights management;
a means for determining whether a client is the client who uploaded a binary image to the warehouse;
a means for a client to request a search of the warehouse using a search term;
a means for searching the warehouse for binary images based on a search term;
a means for delivering information to a client indicating what binary images are available for purchase based on the client's search request;
a means for a client to pay for a binary image; and
a means for delivering a binary image to a client upon receipt of payment;
a means for paying the client who uploaded a binary image, when the binary image is sold to a client; and
a means for the client who uploaded a binary image to the warehouse to remove the binary image from the warehouse.

15. The system of claim 14, further comprising:
a means for the client who uploaded a binary image to the warehouse to edit the binary image;
a means for the client who uploaded a binary image to the warehouse to obtain a report about the sales activity of the binary image; and
a means for paying a client whose uploaded binary image sold.

16. The system of claim 14, further comprising:
a means for a client to indicate a search term and to subscribe to and be notified whenever a binary image identifiable by the search term is uploaded to the warehouse.

17. A system for receiving, storing, searching, selling, and delivering binary images, the system comprising:
a network connection transferring messages to and from plural clients, the messages comprising requests to receive, search, purchase, and deliver binary images; and
a searchable warehouse for storing binary images received from plural clients, for each such binary image, the searchable warehouse comprising information indicating an identifiable client who requested uploading the binary image and an offering price set by the identifiable client;
a server for receiving a request from a client to upload a binary image and an offering price for the binary image, storing the binary image in the searchable warehouse indicating that the client is the identifiable client and the offering price is the offering price set by the identifiable client;
receiving a request from a client, the request comprising a search term, searching the searchable warehouse for a binary image identifiable by the search term, offering a binary image identifiable by the search term to the client at the offering price for the identified binary image, receiving a purchase request for the identified binary image from the client comprising a method to pay the offering price, delivering the binary image to the client; and
upon the sale of a binary image, crediting the account of the corresponding identifiable client for the binary image.

18. The system of claim 17, the server further comprising:
receiving a sales report request from an identifiable client, reporting sales activity of a binary image uploaded by the identifiable client; and
receiving a request to remove a binary image, determining that the request is from the identifiable uploading client for the binary image, and removing the binary image from the searchable warehouse.

19. The system of claim 17, the server further comprising:
receiving a request to edit a binary image, determining that the request is from the identifiable client for the binary image, the request comprising changes to the binary image, and changing the binary image in the searchable warehouse accordingly.

20. A computer implemented electronic publishing method, a server, plural clients, and an electronic storage, the method comprising:
receiving by the server from a first client, an electronic document and an offering price;
storing the electronic document and the offering price in the electronic storage;
encrypting the document and protecting with digital rights management;
receiving a search term from a second client;
determining that the electronic document is identifiable using the search term;
sending information to the second client indicating that the electronic document is available for purchase at the offering price;
receiving from the second client a request to purchase the electronic document including account payment information;
sending the electronic document, and or request for permissions to the second client; and
indicating in an account of the first client, the purchase of the electronic document.
